(19) United States
(12) Patent Application Publication
(10) Pub. No.: US 2026/0177858 A1
(43) Pub. Date: Jun. 25, 2026

(54) LIQUID CRYSTAL DISPLAY DEVICE

(71) Applicant: Sharp Kabushiki Kaisha, Osaka (JP)

(72) Inventor: Shinji SHIMADA, Sakai City (JP)

(21) Appl. No.: 19/418,515

(22) Filed: Dec. 12, 2025

(30) Foreign Application Priority Data
Dec. 23, 2024 (JP) 2024-226516

(51) Int. Cl. G02F 1/1335; G02F 1/137

(52) U.S. Cl. CPC G02F 1/133531; G02F 1/13706; G02F 1/13712

(57) ABSTRACT

A liquid crystal display device having a plurality of picture elements arranged in a matrix including a plurality of rows and a plurality of columns includes a first polarizing plate having a first polarizing axis, a first substrate, a liquid crystal layer containing liquid crystal molecules, a second substrate, and a second polarizing plate having a second polarizing axis. The first substrate further includes a first electrode, an insulating layer, and a second electrode in which elongated openings extending along a row direction or a column direction of the plurality of picture elements are provided separately for each of the picture elements. In a plan view, the second polarizing axis is placed parallel or orthogonal to a longitudinal direction of the openings and is placed at an angle of 80 degrees or larger and 89 degrees or smaller with respect to the first polarizing axis.

### BACKGROUND

### 1. Field

The present disclosure relates to a liquid crystal display device.

### 2. Description of the Related Art

As a technology related to a liquid crystal display device, Japanese Unexamined Patent Application Publication No. 10-90704 discloses a display panel of an in-plane switching driven liquid crystal display device. The display panel includes a liquid crystal layer, first and second transparent substrates facing each other across the liquid crystal layer, a plurality of electrode pairs placed on top of a surface of the first transparent substrate, a first alignment film formed between the liquid crystal layer and the first transparent substrate by an alignment process performed on the first transparent substrate with the plurality of electrode pairs placed on the first transparent substrate, and a second alignment film formed between the liquid crystal layer and the second transparent substrate by an alignment process performed on the second transparent substrate. Each of the electrode pairs is composed of two combtooth electrodes each having a plurality of combtooth portions. The two combtooth electrodes are arranged such that the plurality of combtooth portions of one of the two combtooth electrodes and the plurality of combtooth portions of the other of the two combtooth electrodes alternate. A direction of the alignment process performed on the first transparent substrate is perpendicular to a direction of the alignment process performed on the second transparent substrate. Furthermore, the liquid crystal layer has a chiral agent added thereto.

Japanese Unexamined Patent Application Publication No. 2009-222829 discloses a liquid crystal display device including a pair of substrates, a liquid crystal layer sandwiched between the pair of substrates, first and second electrodes provided at a side of one of the pair of substrates that faces the liquid crystal layer, and alignment films provided separately at each of surfaces of the pair of substrates that face the liquid crystal layer. Alignment directions of the alignment films provided separately at each of the pair of substrates are parallel to each other. The first electrode is provided with a plurality of band electrodes extending in such a direction as to obliquely cross the alignment directions of the alignment films. The liquid crystal layer has added thereto a chiral agent that causes liquid crystal molecules to rotate in the same direction as that in which the liquid crystal molecules rotate when an electric field is generated between the band electrodes and the second electrode.

International Publication No. 2016/208516 discloses a liquid crystal display panel including a liquid crystal cell having a first substrate, a second substrate, and a liquid crystal layer provided between the first substrate and the second substrate, a first polarizing plate placed at the back of the liquid crystal cell, and a second polarizing plate placed at a side of the liquid crystal cell that faces a viewer. The first substrate has an electrode pair that generates a transverse electric field in the liquid crystal layer. The liquid crystal layer is such that Δnd is less than 550 nm when Δn is the birefringence index of nematic liquid crystals and d is the thickness of the liquid crystal layer. The liquid crystal layer is in a state of twist alignment in the absence of the application of a voltage. The absolute value |S3|of a Stokes parameter S3 is such that |S3|of polarized light having passed through the liquid crystal layer is greater than or equal to 0.85 when polarized light of 1.00 is let in. The first polarizing plate and the second polarizing plate are circularly polarizing plates or elliptically polarizing plates having an ellipticity of 0.422 or greater. The first polarizing plate is substantially composed only of a first linearly polarizing layer and a first phase difference layer. The second polarizing plate is substantially composed only of a second linearly polarizing layer and a second phase difference layer.

It is desirable to provide a liquid crystal display device that makes it possible to easily design an outgoing light side optical system.

### SUMMARY

According to an aspect of the disclosure, there is provided a liquid crystal display device having a plurality of picture elements arranged in a matrix including a plurality of rows and a plurality of columns. The liquid crystal display device includes a first polarizing plate having a first polarizing axis, a first substrate having a plurality of non-linear elements placed separately in correspondence with each of the picture elements, a liquid crystal layer containing liquid crystal molecules, a second substrate, and a second polarizing plate having a second polarizing axis. The first polarizing plate, the first substrate, the liquid crystal layer, the second substrate, and the second polarizing plate are arranged in this order from a back side toward a viewing screen side. The first substrate further includes a first electrode, an insulating layer, and a second electrode in which elongated openings extending along a row direction or a column direction of the plurality of picture elements are provided separately for each of the picture elements. The first electrode, the insulating layer, and the second electrode are arranged in this order toward the liquid crystal layer. In a plan view, the second polarizing axis is placed parallel or orthogonal to a longitudinal direction of the openings and is placed at an angle of 80 degrees or larger and 89 degrees or smaller with respect to the first polarizing axis.

### BRIEF DESCRIPTION OF THE DRAWINGS

FIG. 1 is a plan schematic view of a liquid crystal display device according to Embodiment 1;

FIG. 2 is an enlarged plan schematic view of the liquid crystal display device according to Embodiment 1;

FIG. 3 is an enlarged schematic view of an area surrounded by a dashed frame in FIG. 2;

FIG. 4 is a cross-sectional view of the liquid crystal display device according to Embodiment 1 as taken along line IV-IV in FIG. 3;

FIG. 5 is an enlarged plan schematic view of a liquid crystal display device according to a modification of Embodiment 1;

FIG. 6 is an enlarged plan schematic view of a liquid crystal display device according to Embodiment 2;

FIG. 7 is an enlarged plan schematic view of a liquid crystal display device according to a modification of Embodiment 2;

FIG. 8 is a plan schematic view of an FFS mode liquid crystal display device of a comparative embodiment; and

FIG. 9 is an enlarged plan schematic view of the FFS mode liquid crystal display device of the comparative embodiment.

### DESCRIPTION OF THE EMBODIMENTS

The following describes embodiments of the present disclosure. The present disclosure is not limited in content to the following description of the embodiments but can be appropriately designed and changed within such a range as to fulfill a configuration of the present disclosure. In the following description, identical components or components having similar functions are appropriately given identical reference signs that are adhered to throughout different drawings, and a repeated description of such components is appropriately omitted. Aspects of the present disclosure may be appropriately combined with one another without departing from the scope of the present disclosure.

### Embodiment 1

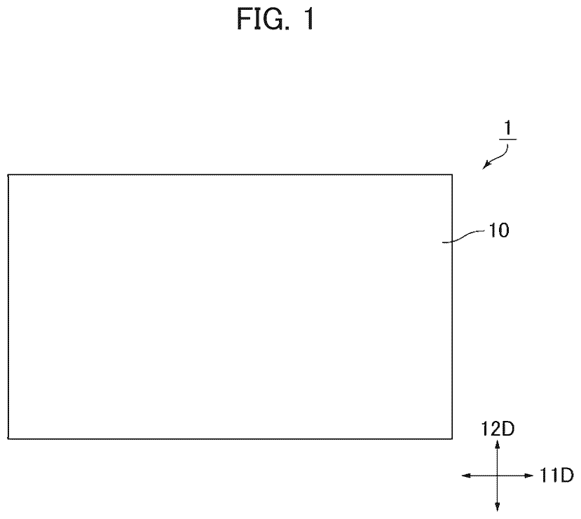

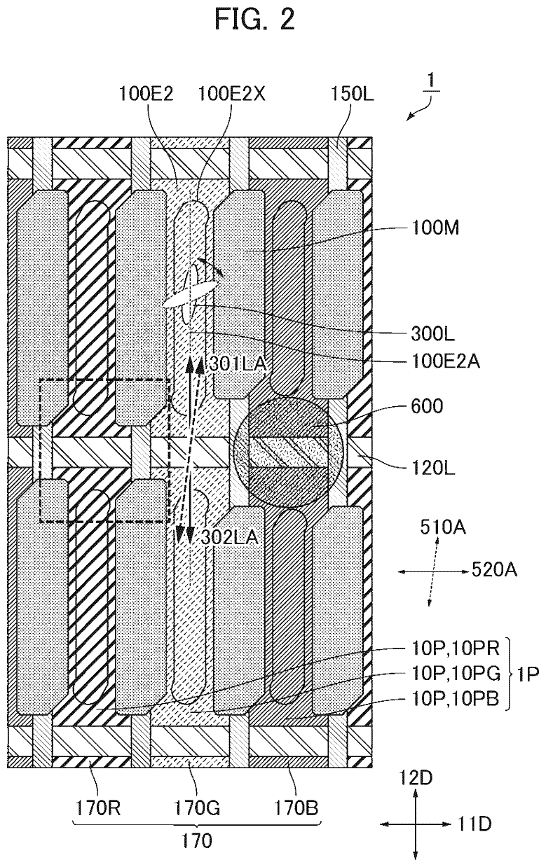

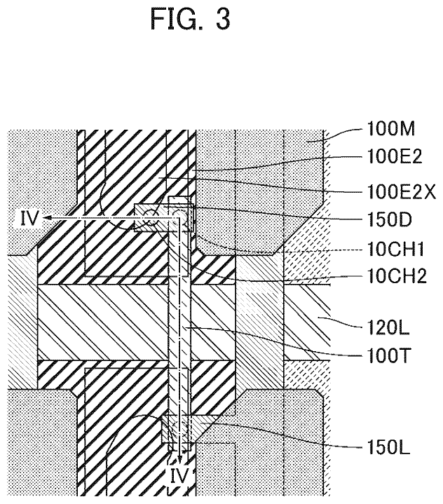

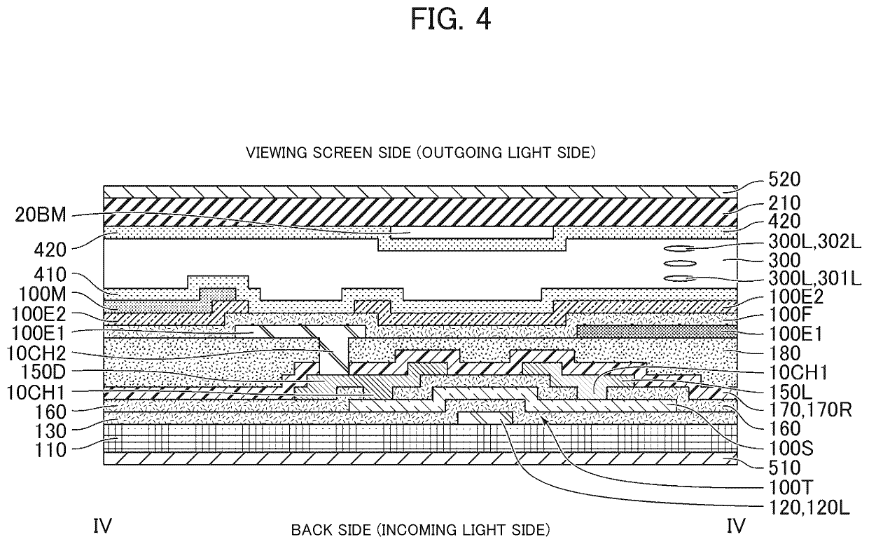

FIG. 1 is a plan schematic view of a liquid crystal display device according to Embodiment 1. FIG. 2 is an enlarged plan schematic view of the liquid crystal display device according to Embodiment 1. FIG. 3 is an enlarged schematic view of an area surrounded by a dashed frame (dashed quadrangular frame) in FIG. 2. FIG. 4 is a cross-sectional view of the liquid crystal display device according to Embodiment 1 as taken along line IV-IV in FIG. 3.

As shown in FIGS. 1 to 4, the liquid crystal display device 1 of the present embodiment has a plurality of picture elements 10P arranged in a matrix including a plurality of rows and a plurality of columns. The liquid crystal display device 1 includes a first polarizing plate 510 having a first polarizing axis 510A, a first substrate 100 having a plurality of non-linear elements 100T placed separately in correspondence with each of the picture elements 10P, a liquid crystal layer 300 containing liquid crystal molecules 300L, a second substrate 200, and a second polarizing plate 520 having a second polarizing axis 520A. The first polarizing plate 510, the first substrate 100, the liquid crystal layer 300, the second substrate 200, and the second polarizing plate 520 are arranged in this order from a back side toward a viewing screen side. The first substrate 100 further includes a first electrode 100E1, an insulating layer 100F, and a second electrode 100E2 in which elongated openings 100E2X extending along a row direction or a column direction of the plurality of picture elements 10P are provided separately for each of the picture elements 10P. The first electrode 100E1, the insulating layer 100F, and the second electrode 100E2 are arranged in this order toward the liquid crystal layer 300. The liquid crystal display device 1 of such an aspect is capable of performing a display by generating a transverse electric field (fringe field) in the liquid crystal layer 300 by applying a voltage between the first electrode 100E1 and the second electrode 100E2 and can suppress a color shift within a viewing angle. The liquid crystal display device 1 is an FFS (fringe field switching) mode liquid crystal display device.

In a plan view, the second polarizing axis 520A is placed parallel or orthogonal to a longitudinal direction 100E2A of the openings 100E2X and is placed at an angle of 80 degrees or larger and 89 degrees or smaller with respect to the first polarizing axis 510A. In the liquid crystal display device 1 of such an aspect, while a reduction in contrast of the liquid crystal display device 1 is suppressed, the second polarizing axis 520A and the longitudinal direction 100E2A of the openings 100E2X can each be placed parallel to a horizontal direction 11D or a vertical direction 12D of a screen 10 of the liquid crystal display device 1. This makes it easy to design an outgoing light side optical system.

That two straight lines (including axes, directions, and azimuths) are parallel to each other herein means that they form an angle (absolute value) of 0 degree or larger and 1 degree or smaller, preferably 0 degree (completely parallel). Further, that two straight lines (including axes, directions, and azimuths) are orthogonal to each other herein means that they form an angle larger than 89 degrees and smaller than or equal to 90 degrees, preferably 90 degrees (completely orthogonal).

In the liquid crystal display device 1 of the present embodiment, the angle formed by the first polarizing axis 510A and the second polarizing axis 520A is not 90 degrees, so that there is concern about leakage of light (reduction in contrast); however, if a difference between an alignment direction 301LA of liquid crystal molecules 301L beside the first substrate 100 and an alignment direction 302LA of liquid crystal molecules 302L beside the second substrate 200 in the absence of the application of a voltage is smaller than or equal to 10 degrees, the optical activity of the liquid crystal molecules 300L gives image quality falling within a practical range as a display on a head-mounted display (HMD).

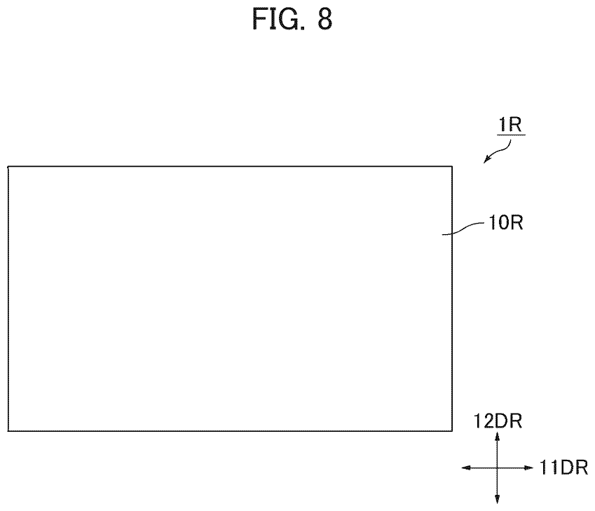

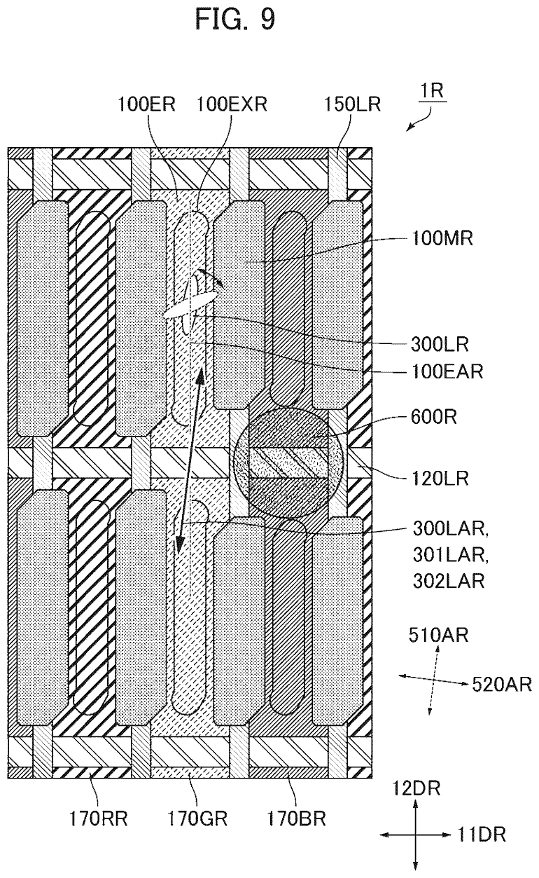

In most cases, liquid crystal display devices for use in HMDs employ an FFS mode as a display mode to suppress a color shift within a viewing angle. FIG. 8 is a plan schematic view of an FFS mode liquid crystal display device of a comparative embodiment. FIG. 9 is an enlarged plan schematic view of the FFS mode liquid crystal display device of the comparative embodiment.

As shown in FIGS. 8 and 9, the FFS mode liquid crystal display device 1R of the comparative embodiment includes a first polarizing plate having a first polarizing axis 510AR, a first substrate, a liquid crystal layer containing liquid crystal molecules 300LR, a second substrate, and a second polarizing plate having a second polarizing axis 520AR. The first polarizing plate, the first substrate, the liquid crystal layer, the second substrate, and the second polarizing plate are arranged in this order from a back side toward a viewing screen side. The liquid crystal display device 1R further includes an elongated light-shielding film 100MR, a red color filter 170RR, a green color filter 170GR, a blue color filter 170BR, and a photo spacer 600R.

The first substrate includes a gate line 120LR, a source line 150LR, and a pair of electrodes one of which is an electrode 100ER having elongated openings 100EXR provided therein. The openings 100EXR provided in the electrode 100ER are also called “slits” or “pixel slits”.

In order to bring the liquid crystal molecules 300LR into unidirectional movement, the FFS mode liquid crystal display device 1R is configured such that in a plan view, an alignment direction 300LAR of the liquid crystal molecules 300LR in the absence of the application of a voltage is placed at an angle of approximately 5 degrees or larger and 15 degrees or smaller with respect to a longitudinal direction 100EAR of the openings 100EXR of the electrode 100ER. Specifically, in a plan view, an alignment direction 301LAR of liquid crystal molecules beside the first substrate and an alignment direction 302LAR of liquid crystal molecules beside the second substrate in the absence of the application of a voltage are each placed at an angle of approximately 5 degrees or larger and 15 degrees or smaller with respect to the longitudinal direction 100EAR of the openings 100EXR of the electrode 100ER.

In recent years, along with an increase in pixel resolution, it has been proposed, out of the need for improvement in transmittance and a reduction in mixture of colors in an oblique view, that in a plan view, a longitudinal direction of openings (pixel slits) of an electrode, a direction of extension of a source line, and a longitudinal direction of a light-shielding film be placed parallel to a horizontal direction or a vertical direction of a screen of a liquid crystal display device.

However, as mentioned above, the FFS mode liquid crystal display device 1R shown in FIG. 9 is configured such that in a plan view, the alignment direction 300LAR of the liquid crystal molecules 300LR in the absence of the application of a voltage is placed at an angle of approximately 5 degrees or larger and 15 degrees or smaller with respect to the longitudinal direction 100EAR of the openings 100EXR of the electrode 100ER. Accordingly, in a case where the longitudinal direction 100EAR of the openings 100EXR of the electrode 100ER is placed parallel to a horizontal direction 11DR or a vertical direction 12DR of a screen 10R of the liquid crystal display device 1R and a normal polarizing plate arrangement (crossed-nicols arrangement) in which the first polarizing axis 510AR and the second polarizing axis 520AR are orthogonal to each other is adopted, the first polarizing axis 510AR of the first polarizing plate located at an incoming light side (back side) and the second polarizing axis 520AR of the second polarizing plate located at an outgoing light side (viewing screen side) each need to form an angle of approximately 5 degrees or larger and 15 degrees or smaller with respect to the horizontal direction 11DR of the screen 10R of the liquid crystal display device 1R or the vertical direction 12DR of the screen 10R in conformance with the alignment direction 300LAR of the liquid crystal molecules 300LR in the initial stage (i.e. in the absence of the application of a voltage). In the foregoing configuration, it is difficult, due to a distortion of a color shift or other factors, to design or manufacture an outgoing light side optical system, which needs a lens and a mirror, although the settings of incoming light side members or other settings are almost free of influence.

The following describes the liquid crystal display device 1 of the present embodiment in detail.

As shown in FIGS. 1 to 4, the liquid crystal display device 1 of the present embodiment includes a first polarizing plate 510 having a first polarizing axis 510A, a first substrate 100, a liquid crystal layer 300 containing liquid crystal molecules 300L, a second substrate 200, and a second polarizing plate 520 having a second polarizing axis 520A. The first polarizing plate 510, the first substrate 100, the liquid crystal layer 300, the second substrate 200, and the second polarizing plate 520 are arranged in this order from a back side toward a viewing screen side. The liquid crystal display device 1 may include a first alignment film 410 between the first substrate 100 and the liquid crystal layer 300. Similarly, the liquid crystal display device 1 may include a second alignment film 420 between the second substrate 200 and the liquid crystal layer 300. The liquid crystal display device 1 may further include a backlight at a side of the first polarizing plate 510 that faces away from the liquid crystal layer 300.

The liquid crystal display device 1 includes an active area (image display area) where an image is displayed, and the active area is composed of a plurality of picture elements 10P arrayed in a matrix in a horizontal direction 11D of a screen 10 and a vertical direction 12D of the screen 10.

The first substrate 100 includes a first support substrate 110, a plurality of gate lines 120L placed at a side of the first support substrate 110 that faces the liquid crystal layer 300, a first insulating layer 130 placed at a side of the plurality of gate lines 120L that faces the liquid crystal layer 300, and a plurality of source lines 150L placed at a side of the first insulating layer 130 that faces the liquid crystal layer 300. The plurality of gate lines 120L are placed parallel to the horizontal direction 11D of the screen 10. The plurality of source lines 150L are placed parallel to the vertical direction 12D of the screen 10. The plurality of gate lines 120L and the plurality of source lines 150L are formed in a grid pattern as a whole so as to demarcate each picture element 10P. A non-linear element 100T is placed at a point of intersection of each gate line 120L and each source line 150L.

In the present embodiment, the horizontal direction 11D forms an angle of 90 degrees with respect to the vertical direction 12D. In the present embodiment, the horizontal direction 11D corresponds to a row direction of picture elements 10P arranged in a matrix (hereinafter sometimes simply referred to as “row direction”), and the vertical direction 12D corresponds to a column direction of picture elements 10P arranged in a matrix (hereinafter sometimes simply referred to as “column direction”).

Although, in the present embodiment, the gate lines 120L are placed parallel to the horizontal direction 11D of the screen 10 and the source lines 150L are placed parallel to the vertical direction 12D of the screen 10, the gate lines 120L may be placed parallel to the vertical direction 12D of the screen 10 and the source lines 150L may be placed parallel to the horizontal direction 11D of the screen 10.

Each non-linear element 100T is a three-terminal switch (e.g. a thin-film transistor (TFT)) having a gate electrode, connected to a corresponding one of the plurality of gate lines 120L and a corresponding one of the plurality of source lines 150L, that protrudes from the corresponding gate line 120L (as part of the gate line 120L), a source electrode protruding from the corresponding source line 150L (as part of the source line 150L), a drain electrode 150D connected to a corresponding one of a plurality of pixel electrodes (in the present embodiment, first electrodes 100E1), and a semiconductor layer 100S. The source electrode and the drain electrode 150D are electrodes provided at the same source wiring layer 150 as the source line 150L, and the gate electrode is an electrode provided at the same gate wiring layer 120 as the gate line 120L. The semiconductor layer 100S is connected to the drain electrode 150D via a through-hole 10CH1. The first electrode 100E1 is connected to the drain electrode 150D via a through-hole 10CH2.

The liquid crystal display device 1 includes a gate driver connected to the gate lines 120L, a source driver connected to the source lines 150L, and a controller connected to the gate driver and the source driver. The gate driver supplies the gate lines 120L with scanning signals in sequence based on control exercised by the controller. At a timing when the non-linear elements 100T are brought by the scanning signals into the presence of the application of a voltage, the source driver supplies the source lines 150L with data signals based on control exercised by the controller.

Each of the pixel electrodes is set to a potential corresponding to a data signal supplied via a corresponding one of the non-linear elements 100T, and a fringe field is generated between the common electrode and the pixel electrode, so that the liquid crystal molecules 300L of the liquid crystal layer 300 rotate. By thus changing the retardation of the liquid crystal layer 300 by controlling the magnitude of a voltage that is applied between the common electrode and the pixel electrode, whether to transmit or not to transmit light is controlled.

The various types of wire and electrode that constitute the gate line 120L, the source line 150L, and the non-linear element 100T can be formed by forming a film of a metal such as copper, titanium, aluminum, molybdenum, or tungsten or an alloy thereof in a single layer or multiple layers by sputtering or other methods and then patterning the film by photolithography or other methods. Those of the various types of wire and electrode which are formed at the same layer are efficiently manufactured by using the same material.

The first substrate 100 includes the first support substrate 110, the gate wiring layer 120, at which the gate line 120L is provided, the first insulating layer 130, the semiconductor layer 100S, the source wiring layer 150, at which the source line 150L is provided, a second insulating layer 160, a color filter layer 170, a planarizing film 180, a first electrode 100E1, an insulating layer 100F, a second electrode 100E2 having an opening 100E2X provided therein, and a light-shielding film 100M in this order toward the liquid crystal layer 300.

The first insulating layer 130 is a gate insulating layer. The first insulating layer 130 is, for example, an inorganic insulating layer. Usable examples of the inorganic insulating layer include an inorganic film (relative dielectric constant ε=5 to 7) of, for example, silicon nitride (SiNₓ) or silicon oxide (SiO₂) and a laminated film thereof.

It is preferable that the semiconductor layer 100S contain an oxide semiconductor or p-Si (polycrystalline silicon). Possible examples of the oxide semiconductor include, but are not limited to, IGZO (registered trademark) (In—Ga—Zn—O: indium oxide-gallium-zinc) and ZnO (zinc oxide).

The second insulating layer 160 is, for example, an inorganic insulating film. Usable examples of the inorganic insulating film include an inorganic film (relative dielectric constant ε=5 to 7) of, for example, silicon nitride (SiNₓ) or silicon oxide (SiO₂) and a laminated film thereof.

The first substrate 100 includes the color filter layer 170. The color filter layer 170 is placed at a side of the second insulating layer 160 that faces the liquid crystal layer 300. The color filter layer 170 is composed of red color filters 170R, blue color filters 170B, and green color filters 170G.

The plurality of picture elements 10P include red picture elements 10PR including the red color filters 170R, blue picture elements 10PB including the blue color filters 170B, and green picture elements 10PG including the green color filters 170G. One pixel 1P is constituted by three picture elements 10P, namely a red picture element 10PR, a blue picture element 10PB, and a green picture element 10PG. In one pixel 1P, these three picture elements 10P are arranged in stripes.

Although, in the present embodiment, the first substrate 100 includes the color filter layer 170, not the first substrate 100 but the second substrate 200 may include the color filter layer 170. The color filter layer 170 is, for example, a micro color filter layer.

The planarizing film 180 is placed at a side of the color filter layer 170 that faces the liquid crystal layer 300. The planarizing film 180 is an insulating film that absorbs asperities on a surface (foundation) on which the film is formed and that planarizes a substrate surface on which the film has been formed. The planarizing film 180 allows the liquid crystal display device 1 to remain the same in cell thickness. As the planarizing film 180, an organic insulating film is suitable. A usable example of the organic insulating film is an organic film of, for example, acrylic resin, polyimide resin, or novolak resin. A suitably usable example of the organic insulating film is an organic film of, for example, photosensitive acrylic resin with a low relative dielectric constant (relative dielectric constant ε=2 to 5).

The first substrate 100 of the present embodiment may include a color filter layer 170 and a planarizing film 180 placed at a side of the color filter layer 170 that faces the liquid crystal layer 300. Such an aspect makes it possible to greatly reduce the effect on an aperture shape (aperture ratio) of the pixel 1P by a misalignment during the bonding together of the first substrate 100 and the second substrate 200.

The first substrate 100 includes a first electrode 100E1 and a second electrode 100E2 having provided therein openings 100E2X extending along the row direction or the column direction of the plurality of picture elements 10P, and the first electrode 100E1 and the second electrode 100E2 at least partially face each other across the insulating layer 100F. That is, the first substrate 100 includes, in sequence, the first electrode 100E1, the insulating layer 100F, and the second electrode 100E2, which has provided therein openings 100E2X extending along the row direction or the column direction of the plurality of picture elements 10P. Such an aspect makes it possible to achieve the FFS mode as a display mode. That the first electrode 100E1 and the second electrode 100E2 partially face each other here means that at least part of the first electrode 100E1 faces at least part of the second electrode 100E2. In the second electrode 100E2, the elongated opening 100E2X are provided separately (only one by one) for each of the picture elements 10P.

One of the first electrode 100E1 and the second electrode 100E2 is a pixel electrode, and the other is a common electrode. In the present embodiment, the first electrode 100E1 is a pixel electrode, and the second electrode 100E2 is a common electrode.

The pixel electrode is an electrode placed in each area surrounded by two gate lines 120L that are adjacent to each other and two source lines 150L that are adjacent to each other. The pixel electrode is placed in each picture element 10P. The pixel electrode is connected to the corresponding non-linear element 100T and is connected to the corresponding source line 150L via the semiconductor layer 100S of the non-linear element 100T. The pixel electrode is set to a potential corresponding to a data signal that is supplied via the corresponding non-linear element 100T.

The common electrode is an electrode formed substantially all over the picture elements 10P regardless of the boundaries between the picture elements 10P. The common electrode is supplied with a common signal kept at a certain value, so that the common electrode is kept at a certain potential.

The first substrate 100 may include a gate line 120L, and in a plan view, the gate line 120L may be placed orthogonal to the longitudinal direction 100E2A of the openings 100E2X. In the liquid crystal display device 1 of such an aspect, one of a direction of extension of the gate line 120L and the longitudinal direction 100E2A of the openings 100E2X is placed parallel to the horizontal direction 11D of the screen 10, and the other can be placed parallel to the vertical direction 12D of the screen 10. This makes it possible to achieve improvement in transmittance and a reduction in mixture of colors in an oblique view while achieving an increase in resolution.

The second electrode 100E2 is placed closer to the liquid crystal layer 300 than is the first electrode 100E1. The opening 100E2X of the (upper-layer) second electrode 100E2 placed closer to the liquid crystal layer 300 is placed over the lower-layer first electrode 100E1. Although, in the present embodiment, the lower-layer first electrode 100E1 is placed in an area corresponding to at least the opening 100E2X, there may be an area where the first electrode 100E1 is not present in the area corresponding to the opening 100E2X. For example, in a case where the lower-layer first electrode 100E1 is a common electrode, the first electrode 100E1 may be a solid electrode having an opening provided in an area corresponding to a through-hole connecting the upper-layer second electrode 100E2, which is a pixel electrode, with the drain electrode of the non-linear element 100T. Since an electric field that is applied to liquid crystal molecules 300L is determined by a potential difference between the opening 100E2X of the upper-layer second electrode 100E2 and the lower-layer first electrode 100E1, either the upper-layer electrode (second electrode 100E2) or the lower-layer electrode (first electrode 100E1) may be a pixel electrode or a common electrode in terms of how the liquid crystal molecules move. In a case where the upper-layer electrode is a pixel electrode, the upper-layer electrode has a configuration in which one opening 100E2X is provided in each quadrangular pixel electrode, as the pixel electrode needs to be electrically insulated from an adjacent pixel electrode. Meanwhile, in a case where the upper-layer electrode is a common electrode, the upper-layer electrode has a configuration in which one opening 100E2X (i.e. as many openings as picture elements in the common electrode as a whole) is provided in an area corresponding to each picture element of a solid electrode spread over the entire area of the screen.

It is preferable that the first electrode 100E1 be a pixel electrode and that the second electrode 100E2 be a common electrode. Such an aspect makes it possible to make a step attributed to an electrode smaller. This also makes it possible to easily form a through-hole 10CH2 between the pixel electrode and the drain electrode. Specifically, this makes it hard for there to occur positional interference of the through-hole 10CH2 and the light-shielding film 100M, making it easy to design the liquid crystal display device 1. Further, in a case where the light-shielding film 100M is a conductor such as a metal, it becomes hard for there to occur electrical interference of the through-hole 10CH2 and the light-shielding film 100M, making it easy to design the liquid crystal display device 1.

The first electrode 100E1 may be a common electrode, and the second electrode 100E2 may be a pixel electrode. Such an aspect makes it possible to decrease a parasitic capacitance [Cgd} of the non-linear element 100T.

The first electrode 100E1 and the second electrode 100E2 can be formed, for example, by forming a film of a transparent conductive material such as indium tin oxide (ITO), indium zinc oxide (IZO), zinc oxide (ZnO), or tin oxide (SnO) or an alloy thereof in a single layer or multiple layers by sputtering or other methods and then patterning the film by photolithography or other methods.

The insulating layer 100F is an interlayer insulating film and has a function of insulating the first electrode 100E1 and the second electrode 100E2 from each other. As the insulating layer 100F, an inorganic insulating film can be used. Usable examples of the inorganic insulating film include an inorganic film (relative dielectric constant ε=5 to 7) of, for example, silicon nitride (SiNₓ) or silicon oxide (SiO₂) and a laminated film thereof.

It is preferable that the first substrate 100 include a light-shielding film 100M. The light-shielding film 100M has a function of blocking light. The light-shielding film 100M needs only have an optical absorptance of 30% or higher. It is preferable that the sum of the optical absorptance and reflectance of the light-shielding film 100M be higher than or equal to 80%, more preferably higher than or equal to 95%. The optical absorptance of the light-shielding film 100M is obtained by performing a common reflectance measurement and a common transmittance measurement and subtracting the reflectance and the transmittance from 100%.

It is preferable that the light-shielding film 100M contain a metal. It is preferable that the metal contained in the light-shielding film 100M be a metal, such as molybdenum or titanium, whose reflectance is comparatively low. The light-shielding film 100M may contain a non-metal substance.

The light-shielding film 100M is, for example, a metal film. The metal film has a reflectance of, for example, 40% or higher and 70% or lower. The reflectance can is a reflectance in a visible light region (e.g. wavelengths of 380 nm to 780 nm) and can be measured by a method based on JIS R3106:2019. As a measurement device, a spectrophotometer (e.g. CM-700d manufactured by Konica Minolta, Inc.) can be used.

The light-shielding film 100M may be a layered product including a metal film and an insulating film. The insulating film included in the layered production is, for example, an inorganic insulating film. The layered product may be a layered product in which an insulating film of, for example, silicon oxide or silicon nitride is sandwiched between a plurality of metal films. In a case where the light-shielding film 100M is such a layered product, it is preferable that the metal films included in the layered product be semi-transmissive metal thin-film layers. Such an aspect makes it possible to reduce the reflectance of the light-shielding film 100M by utilizing interference of light.

The first substrate 100 may include an elongated light-shielding film 100M placed between the plurality of picture elements 10P (at boundaries of the picture elements 10P), and in a plan view, a longitudinal direction of the light-shielding film 100M may be placed parallel to the longitudinal direction 100E2A of the openings 100E2X. In the liquid crystal display device 1 of such an aspect, the longitudinal direction of the light-shielding film 100M and the longitudinal direction 100E2A of the openings 100E2X can be placed parallel to the horizontal direction 11D or the vertical direction 12D of the screen 10 of the liquid crystal display device 1. This makes it possible to achieve improvement in transmittance and a reduction in mixture of colors in an oblique view while achieving an increase in resolution.

It is preferable that the light-shielding film 100M be elongated and that between the plurality of picture elements 10P (at boundaries of the picture elements 10P), at least part of the light-shielding film 100M be placed in an island shape to overlap the source lines 150L. Such an aspect makes it possible to suppress a color deviation during monochromatic display due to leakage of light from an adjacent picture element 10P primarily at an oblique viewing angle.

The second substrate 200 includes a second support substrate 210.

The second substrate 200 may have a second substrate side light-shielding film 20BM at a side of the second support substrate 210 that faces the liquid crystal layer 300. The second substrate side light-shielding film 20BM may be provided in a grid pattern so as to demarcate each color filter.

The second substrate side light-shielding film 20BM is, for example, a black matrix layer. The black matrix layer is made of any material that has a light blocking effect; however, as the material, a resin material containing a black pigment or a metal material having a light blocking effect is suitably used. The black matrix layer is formed, for example, by applying photosensitive resin containing a black pigment to form a film and subjecting the film to photolithography, which includes performing exposure, development, or other processes.

It is preferable that the second substrate side light-shielding film 20BM be extended along the row direction (in the present embodiment, the horizontal direction 11D) between two picture elements 10P that are adjacent to each other in the column direction (in the present embodiment, the vertical direction 12D) and not be placed between two picture elements 10P that are adjacent to each other in the row direction (not be extended along the column direction between two picture elements 10P that are adjacent to each other in the row direction). Such an aspect makes it possible to better suppress delamination of the second substrate side light-shielding film 20BM than in a case where the second substrate side light-shielding film 20BM is extended both between two picture elements 10P that are adjacent to each other in the column direction and two picture elements 10P that are adjacent to each other in the row direction. Further, such an aspect makes it possible to, from the point of view of the positioning accuracy with which the first substrate 100 and the second substrate 200 are bonded together, make the aperture ratio higher than in a case where the second substrate side light-shielding film 20BM is extended in the column direction. The second substrate side light-shielding film 20BM is extended, for example, on the outer frame of the screen 10 of the liquid crystal display device 1 and in the row direction between each picture element 10P and the other. Being extended along a certain direction herein means being extended parallel to a certain direction.

A spacer 600 may be provided between the first substrate 100 and the second substrate 200. The spacer 600 has a function of securing a gap of space in which the liquid crystal layer 300 is formed. The spacer 600 is in the shape of, for example, a column. The spacer 600 may be placed on at least either the first substrate 100 or the second substrate 200 or may be placed on both of the substrates. The spacer 600 is provided, for example, in the second substrate 200 and does not need to have its tip in contact with the first substrate 100. The spacer 600 may, for example, be polygonal, circular, or elliptical in planar shape. The spacer 600 is, for example, in the shape of a truncated cone, a circular cylinder, a truncated elliptical cone, a truncated pyramid, a prism, or other shapes. Examples of the truncated pyramid include a truncated quadrangular pyramid. Examples of the prism include a quadrangular prism.

It is preferable that the spacer 600 contain, for example, a hardened material of photosensitive resin. Examples of the photosensitive resin include resin having an ultraviolet reactive functional group.

The liquid crystal layer 300 contains a liquid crystal material and is configured such that the amount of light that travels through the liquid crystal layer 300 is controlled by applying a voltage to the liquid crystal layer 300 and changing a state of alignment of the liquid crystal molecules 300L in the liquid crystal material according to the voltage thus applied. The liquid crystal material exhibits nematic liquid crystallinity within a given temperature range.

The liquid crystal molecules 300L are horizontally aligned in the absence of the application of a voltage. That the liquid crystal molecules 300L are horizontally aligned means that in the absence of the application of a voltage to the liquid crystal layer 300, the liquid crystal molecules 300L in the liquid crystal layer 300 are aligned substantially parallel to a principal surface of the first substrate 100 and a principal surface of the second substrate 200. That the liquid crystal molecules are aligned substantially parallel to the principal surfaces of the substrates here means that the liquid crystal molecules have a pretilt angle of 0 degree or larger and 5 degrees or smaller, preferably 0 degree or larger and 2 degrees or smaller, more preferably 0 degree or larger and 1 degree or smaller, with respect to the principal surfaces of the substrates.

In this specification, the state where a voltage of the threshold or above is applied between the first electrode 100E1 and the second electrode 100E2 is simply referred to as the “presence of the application of a voltage”, and the state where a voltage below the threshold is applied between the first electrode100E1 and the second electrode100E2 (including no voltage applied) is simply referred to as the “absence of the application of a voltage”

Liquid crystal molecules whose dielectric constant anisotropy (Δε) as defined by Formula (L1) below assumes a positive value are called “positive liquid crystals”, and liquid crystal molecules whose dielectric constant anisotropy (Δε) as defined by Formula (L1) below assumes a negative value are called “negative liquid crystals”. A long axis direction of the liquid crystal molecules 300L is an alignment direction (slow axis direction). Further, in the absence of the application of a voltage between the first electrode 100E1 and the second electrode 100E2 (i.e. in the absence of the application of a voltage), the liquid crystal molecules 300L are homogeneously aligned.

$$Δ ε = ( Dielectric constant of liquid crystal molecules in long axis direction ) - ( Dielectric constant of liquid crystal molecules in short axis direction ) \qquad Formula ( L1 )$$

It is preferable that the liquid crystal molecules 300L of the present embodiment have positive dielectric constant anisotropy. The liquid crystal display device 1 of such an aspect can bring about improvement in response speed.

In a plan view, the alignment direction 301LA of the liquid crystal molecules 301L beside the first substrate 100 in the absence of the application of a voltage may be placed at an angle of 1 degree or larger and 10 degrees or smaller in one of a clockwise direction and a counterclockwise direction (in FIG. 2, the clockwise direction) with respect to the longitudinal direction 100E2A of the openings 100E2X. The liquid crystal display device 1 of such an aspect makes it possible to effectively rotate the liquid crystal molecules 300L in a given direction in the presence of the application of a voltage to the liquid crystal layer 300 and can achieve a more satisfactory display.

It is more preferable that in a plan view, the alignment direction 301LA of the liquid crystal molecules 301L beside the first substrate 100 in the absence of the application of a voltage form an angle of 1 degree or larger and 10 degrees or smaller, even more preferably 3 degrees or larger and 7 degrees or smaller, in one of the clockwise direction and the counterclockwise direction (in FIG. 2, the clockwise direction) with respect to the longitudinal direction 100E2A of the openings 100E2X. The liquid crystal display device 1 of such an aspect can achieve a more satisfactory display.

Further, in a plan view, the alignment direction 302LA of the liquid crystal molecules 302L beside the second substrate 200 in the absence of the application of a voltage may be placed parallel to the longitudinal direction 100E2A of the openings 100E2X. In the liquid crystal display device 1 of such an aspect, the second polarizing axis 520A, which is placed parallel or orthogonal to the alignment direction 302LA of the liquid crystal molecules 302L beside the second substrate 200 in the absence of the application of a voltage, and the longitudinal direction 100E2A of the openings 100E2X can be placed parallel to the horizontal direction 11D or the vertical direction 12D of the screen 10 of the liquid crystal display device 1. This makes it possible to easily design an outgoing light side optical system.

In the present embodiment, unless otherwise noted, the alignment direction of liquid crystal molecules is the alignment direction of liquid crystal molecules located in a central part of an opening of the second electrode in a plan view. The central part of the opening is an area of overlap between a central part (i.e. an area extending over a certain range) of the opening in the longitudinal direction and a central part (i.e. an area extending over a certain range) of the opening in a width direction (i.e. a direction forming an angle of 90 degrees with respect to the longitudinal direction). The central part of the opening in the longitudinal direction is, for example, an area located in the middle one of three areas obtained by dividing the opening into three equal parts in the longitudinal direction. The central part of the opening in the width direction is, for example, an area located in the middle one of three areas obtained by dividing the opening into three equal parts in the width direction.

The alignment direction of liquid crystal molecules in the absence of the application of a voltage can be specified in the following manner. Since an alignment film (e.g. a commonly used heat-resistant polymer alignment film) has a phase difference in the alignment direction of liquid crystal molecules, the alignment direction of liquid crystal molecules in the absence of the application of a voltage can be the direction of the phase difference of the alignment film as measured by a micropolarization measurement device (e.g. micropolarization spectrophotometer (manufactured by ORC MANUFACTURING CO., LTD. as TFM-120AFT-PC)). That is, the direction of the phase difference of the first alignment film 410 can be made the alignment direction 301LA of the liquid crystal molecules 301L beside the first substrate 100 in the absence of the application of a voltage. Similarly, the direction of the phase difference of the second alignment film 420 can be made the alignment direction 302LA of the liquid crystal molecules 302L beside the second substrate 200 in the absence of the application of a voltage.

In a case where the phase difference of the alignment film is so minute that it is difficult to specify the direction of the phase difference of the alignment film, the alignment direction of liquid crystal molecules in the absence of the application of a voltage can be a direction of minimum transmittance of polarized light that falls on a layered product including the alignment film, a liquid crystal layer containing liquid crystal molecules, and a polarizing plate in this order and that has a polarizing axis forming an angle of 90 degrees with respect to a transmission axis of the polarizing plate from the direction of the alignment film.

The liquid crystal layer 300 may contain a chiral dopant, the liquid crystal molecules 300L may be in twist alignment, and a value obtained by dividing a thickness of the liquid crystal layer 300 by a twist pitch between the liquid crystal molecules 300L may be less than or equal to 0.125. The liquid crystal display device 1 of such an aspect can increase the response speed of the liquid crystal molecules 300L in the presence of the application of a voltage. The twist pitch is a thickness of the liquid crystal layer 300 that corresponds to a single winding (twist of 360 degrees) of a helical structure.

When, in a plan view, the alignment direction 301LA of the liquid crystal molecules 301L beside the first substrate 100 in the absence of the application of a voltage is greatly inclined with respect to the alignment direction 302LA of the liquid crystal molecules 302L beside the second substrate 200 in the absence of the application of a voltage, there is a reduction in contrast, so that due to the limitation of contrast, a sufficient response speed is unable to be attained.

In the FFS mode liquid crystal display device, generally, a response speed in the presence of the application of a voltage (hereinafter referred to as “Ton”) is much lower than a response speed during a return (hereinafter referred to as “Toff”), and it is Ton that is susceptible to the effect of the alignment angle of liquid crystal molecules. Therefore, in the present embodiment, in which the liquid crystal molecules 300L have positive dielectric constant anisotropy, Ton can be increased by adding the chiral dopant into the liquid crystal layer 300 so that the alignment direction 301LA of the liquid crystal molecules 301L beside the first substrate 100 becomes twisted from the first substrate 100 toward the second substrate 200 in a direction having an inclination with respect to the longitudinal direction 100E2A of the openings 100E2X of the second electrode 100E2. In this case, Toff decreases, so that a balance between Ton and Toff needs to be achieved.

The chiral dopant is not limited to particular chiral dopants, and a conventionally publicly known chiral dopant can be used. Usable examples of chiral agents include S-811 (manufactured by Merck Electronics, Inc.).

The first alignment film 410 and the second alignment film 420 have a function of controlling the alignment of the liquid crystal molecules 300L contained in the liquid crystal layer 300. The first alignment film 410 and the second alignment film 420 are horizontal alignment films. The horizontal alignment films have a function of aligning liquid crystal molecules in the absence of the application of a voltage.

Examples of an alignment process method for the first alignment film 410 include a method (degradative photo-alignment method) in which a macromolecular chain of an alignment film in a certain direction is cut by irradiation with polarized ultraviolet rays, a method (anisotropic photo-alignment method) in which a photosensitive group in an alignment film is brought into a cis-trans isomerization reaction by irradiation with polarized ultraviolet rays, and a method (rubbing alignment method) in which a macromolecular chain on a surface of an alignment film is aligned in a certain direction by rubbing the surface with raised fabric. An alignment process method for the second alignment film 420 is similar to that for the first alignment film 410.

The first polarizing plate 510 has the first polarizing axis 510A. The second polarizing plate 520 has the second polarizing axis 520A. The term “polarizing axis” here means a transmission axis. The first polarizing plate 510 and the second polarizing plate 520 are, for example, absorptive polarizing plates. The first polarizing plate 510 have the first polarizing axis 510A and a first absorption axis orthogonal to the first polarizing axis 510A, and the second polarizing plate 520 have the second polarizing axis 520A and a second absorption axis orthogonal to the second polarizing axis 520A.

In a plan view, the first polarizing axis 510A may be placed parallel or orthogonal to the alignment direction 301LA of the liquid crystal molecules 301L beside the first substrate 100 in the absence of the application of a voltage. The liquid crystal display device 1 of such an aspect can achieve satisfactory image quality with reduced leakage of light. In the present embodiment, in a plan view, the first polarizing axis 510A is placed parallel to the alignment direction 301LA of the liquid crystal molecules 301L beside the first substrate 100 in the absence of the application of a voltage.

In a plan view, the second polarizing axis 520A is placed parallel or orthogonal to the longitudinal direction 100E2A of the openings 100E2X. The liquid crystal display device 1 of such an aspect makes it possible to easily design an outgoing light side optical system. In the present embodiment, in a plan view, the second polarizing axis 520A is placed orthogonal to the longitudinal direction 100E2A of the openings 100E2X.

It is preferable that in a plan view, the second polarizing axis 520A be placed parallel or orthogonal to the alignment direction 302LA of the liquid crystal molecules 302L beside the second substrate 200 in the absence of the application of a voltage. The liquid crystal display device 1 of such an aspect can achieve satisfactory image quality with reduced leakage of light. In the present embodiment, in a plan view, the second polarizing axis 520A is placed orthogonal to the alignment direction 302LA of the liquid crystal molecules 302L beside the second substrate 200 in the absence of the application of a voltage.

In a plan view, the second polarizing axis 520A is placed at an angle of 80 degrees or larger and 89 degrees or smaller with respect to the first polarizing axis 510A. The liquid crystal display device 1 of such an aspect makes it possible to easily design an outgoing light side optical system while suppressing a reduction in contrast of the liquid crystal display device 1 (i.e. while achieving satisfactory image quality with reduced leakage of light). It is preferable that in a plan view, the second polarizing axis 520A be placed at an angle of 83 degrees or larger and 88 degrees or smaller, more preferably 85 degrees or larger and 87 degrees or smaller, with respect to the first polarizing axis 510A. The liquid crystal display device 1 of such an aspect can achieve more satisfactory image quality with reduced leakage of light.

In the present embodiment, as shown in FIG. 2, in a plan view, the first polarizing axis 510A is placed parallel to the alignment direction 301LA of the liquid crystal molecules 301L beside the first substrate 100 in the absence of the application of a voltage, and the second polarizing axis 520A is placed orthogonal to the longitudinal direction 100E2A of the openings 100E2X and the alignment direction 302LA of the liquid crystal molecules 302L beside the second substrate 200 in the absence of the application of a voltage. Alternatively, the first polarizing axis 510A and the second polarizing axis 520A may be set in the following manner. That is, in a plan view, the first polarizing axis 510A may be placed orthogonal to the alignment direction 301LA of the liquid crystal molecules 301L beside the first substrate 100 in the absence of the application of a voltage, and the second polarizing axis 520A may be placed parallel to the longitudinal direction 100E2A of the openings 100E2X and the alignment direction 302LA of the liquid crystal molecules 302L beside the second substrate 200 in the absence of the application of a voltage.

### Modification of Embodiment 1

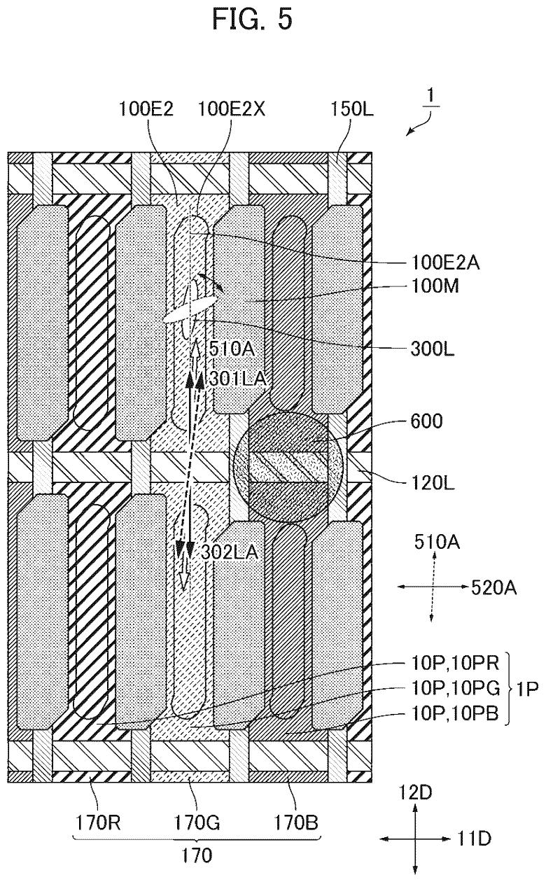

FIG. 5 is an enlarged plan schematic view of a liquid crystal display device according to a modification of Embodiment 1. The liquid crystal display device 1 of the present modification has the same configuration as that of Embodiment 1 except that the placement of the first polarizing axis 510A is different.

The liquid crystal molecules 300L of the present modification have positive dielectric constant anisotropy. As shown in FIG. 5, in a plan view, the alignment direction 301LA of the liquid crystal molecules 301L beside the first substrate 100 in the absence of the application of a voltage is placed at an angle of 1 degree or larger and 10 degrees or smaller in one of a clockwise direction and a counterclockwise direction (in FIG. 5, the clockwise direction) with respect to the longitudinal direction 100E2A of the openings 100E2X, and the first polarizing axis 510A is placed at an angle larger than 0 degree and smaller than or equal to 2 degrees in the other of the clockwise direction and the counterclockwise direction (in FIG. 5, the counterclockwise direction) with respect to the alignment direction 301LA of the liquid crystal molecules 301L beside the first substrate 100 in the absence of the application of a voltage or with respect to a direction perpendicular to the alignment direction 301LA of the liquid crystal molecules 301L beside the first substrate 100 in the absence of the application of a voltage. The liquid crystal display device 1 of such an aspect can bring about further improvement in contrast. A direction perpendicular to a certain direction is herein a direction forming an angle of 90 degrees with a certain direction.

In FIG. 5, in a plan view, the first polarizing axis 510A is placed at an angle larger than 0 degree and smaller than or equal to 2 degrees in the counterclockwise direction with respect to the alignment direction 301LA of the liquid crystal molecules 301L beside the first substrate 100 in the absence of the application of a voltage, and the second polarizing axis 520A is placed orthogonal to the longitudinal direction 100E2A of the openings 100E2X.

Alternatively, in a plan view, the first polarizing axis 510A may be placed at an angle larger than 0 degree and smaller than or equal to 2 degrees in the counterclockwise direction with respect to a direction perpendicular to the alignment direction 301LA of the liquid crystal molecules 301L beside the first substrate 100 in the absence of the application of a voltage, and in a plan view, the second polarizing axis 520A may be placed parallel to the longitudinal direction 100E2A of the openings 100E2X.

In a high-definition liquid crystal display device to which a configuration such as the present modification is applied, the actual alignment direction of the liquid crystal molecules 300L near the light-shielding film 100M deviates by a maximum of approximately 4 degrees due to the effect of a step of the light-shielding film 100M or other factors. Specifically, the actual alignment direction of the liquid crystal molecules 300L near the light-shielding film 100M deviates toward the longitudinal direction 100E2A of the openings 100E2X. Therefore, in the present modification, the contrast of the liquid crystal display device 1 can be made higher than it is in Embodiment 1 by placing the first polarizing axis 510 closer to the longitudinal direction 100E2A of the openings 100E2X than it is in Embodiment 1.

### Embodiment 2

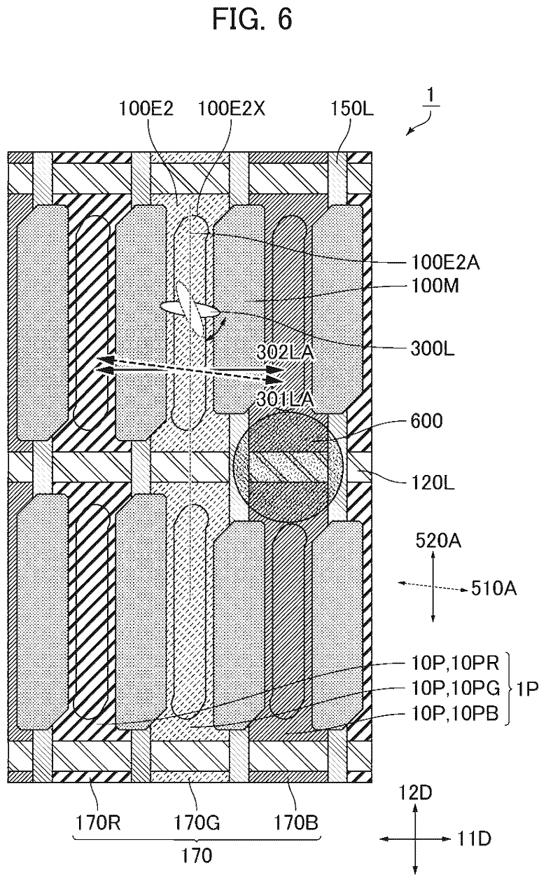

The present embodiment primarily describes features peculiar to the present embodiment and omits a description of contents that overlap those of Embodiment 1 described above. FIG. 6 is an enlarged plan schematic view of a liquid crystal display device according to Embodiment 2. The liquid crystal display device 1 of the present embodiment is substantially the same as that of Embodiment 1 except that the dielectric constant anisotropy of the liquid crystal molecules 300L, the alignment direction of the liquid crystal molecules 300L in the absence of the application of a voltage, and the placement of the first polarizing axis 510A and the second polarizing axis 520A are different.

While the liquid crystal molecules 300L of the liquid crystal display device 1 of Embodiment 1 described above have positive dielectric constant anisotropy, the liquid crystal molecules 300L of the present embodiment have negative dielectric constant anisotropy. Such an aspect makes it possible to bring about improvement in transmittance.

In a plan view, the alignment direction 301LA of the liquid crystal molecules 301L beside the first substrate 100 in the absence of the application of a voltage may be placed at an angle of 1 degree or larger and 10 degrees or smaller in one of a clockwise direction and a counterclockwise direction (in FIG. 6, the clockwise direction) with respect to a direction perpendicular to the longitudinal direction 100E2A of the openings 100E2X. The liquid crystal display device 1 of such an aspect makes it possible to effectively rotate the liquid crystal molecules 300L in a given direction in the presence of the application of a voltage to the liquid crystal layer 300 and can achieve a more satisfactory display.

It is more preferable that in a plan view, the alignment direction 301LA of the liquid crystal molecules 301L beside the first substrate 100 in the absence of the application of a voltage form an angle of 4 degrees or larger and 7 degrees or smaller, even more preferably 3 degrees or larger and 5 degrees or smaller, in one of the clockwise direction and the counterclockwise direction (in FIG. 6, the clockwise direction) with respect to a direction perpendicular to the longitudinal direction 100E2A of the openings 100E2X. The liquid crystal display device 1 of such an aspect can achieve a more satisfactory display.

Further, in a plan view, the alignment direction 302LA of the liquid crystal molecules 302L beside the second substrate 200 in the absence of the application of a voltage may be placed orthogonal to the longitudinal direction 100E2A of the openings 100E2X. In the liquid crystal display device 1 of such an aspect, the second polarizing axis 520A, which is placed parallel or orthogonal to the alignment direction 302LA of the liquid crystal molecules 302L beside the second substrate 200 in the absence of the application of a voltage, and the longitudinal direction 100E2A of the openings 100E2X can be placed parallel to the horizontal direction 11D or the vertical direction 12D of the screen 10 of the liquid crystal display device 1. This makes it possible to easily design an outgoing light side optical system.

In a plan view, the first polarizing axis 510A may be placed parallel or orthogonal to the alignment direction 301LA of the liquid crystal molecules 301L beside the first substrate 100 in the absence of the application of a voltage. The liquid crystal display device 1 of such an aspect can achieve satisfactory image quality with reduced leakage of light. In the present embodiment, in a plan view, the first polarizing axis 510A is placed parallel to the alignment direction 301LA of the liquid crystal molecules 301L beside the first substrate 100 in the absence of the application of a voltage.

In a plan view, the second polarizing axis 520A is placed parallel or orthogonal to the longitudinal direction 100E2A of the openings 100E2X. The liquid crystal display device 1 of such an aspect makes it possible to easily design an outgoing light side optical system. In the present embodiment, in a plan view, the second polarizing axis 520A is placed orthogonal to the longitudinal direction 100E2A of the openings 100E2X.

It is preferable that in a plan view, the second polarizing axis 520A be placed parallel or orthogonal to the alignment direction 302LA of the liquid crystal molecules 302L beside the second substrate 200 in the absence of the application of a voltage. The liquid crystal display device 1 of such an aspect can achieve satisfactory image quality with reduced leakage of light. In the present embodiment, in a plan view, the second polarizing axis 520A is placed orthogonal to the alignment direction 302LA of the liquid crystal molecules 302L beside the second substrate 200 in the absence of the application of a voltage.

In the present embodiment, as shown in FIG. 6, in a plan view, the first polarizing axis 510A is placed parallel to the alignment direction 301LA of the liquid crystal molecules 301L beside the first substrate 100 in the absence of the application of a voltage, and the second polarizing axis 520A is placed parallel to the longitudinal direction 100E2A of the openings 100E2X and is placed orthogonal to the alignment direction 302LA of the liquid crystal molecules 302L beside the second substrate 200 in the absence of the application of a voltage. Alternatively, the first polarizing axis 510A and the second polarizing axis 520A may be set in the following manner. That is, in a plan view, the first polarizing axis 510A may be placed orthogonal to the alignment direction 301LA of the liquid crystal molecules 301L beside the first substrate 100 in the absence of the application of a voltage, and the second polarizing axis 520A may be placed orthogonal to the longitudinal direction 100E2A of the openings 100E2X and may be placed parallel to the alignment direction 302LA of the liquid crystal molecules 302L beside the second substrate 200 in the absence of the application of a voltage.

The liquid crystal layer 300 may contain a chiral dopant, the liquid crystal molecules 300L may be in twist alignment, and a value obtained by dividing a thickness of the liquid crystal layer 300 by a twist pitch between the liquid crystal molecules 300L may be less than or equal to 0.125.

In the present embodiment, in which the liquid crystal molecules 300L have negative dielectric constant anisotropy, Ton can be increased by adding the chiral dopant into the liquid crystal layer 300 so that the alignment direction 301LA of the liquid crystal molecules 301L beside the first substrate 100 becomes twisted from the first substrate 100 toward the second substrate 200 in a direction having an inclination with respect to a direction perpendicular to the longitudinal direction 100E2A of the openings 100E2X of the second electrode 100E2.

### Modification of Embodiment 2

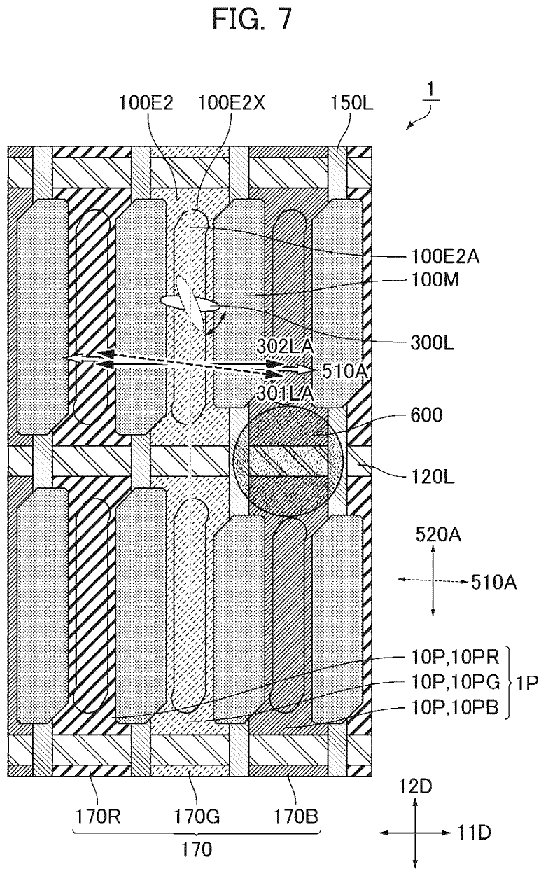

FIG. 7 is an enlarged plan schematic view of a liquid crystal display device according to a modification of Embodiment 2. The liquid crystal display device 1 of the present modification has the same configuration as that of Embodiment 2 except that the placement of the first polarizing axis 510A is different.

The liquid crystal molecules 300L of the present modification have negative dielectric constant anisotropy. As shown in FIG. 7, in a plan view, the alignment direction 301LA of the liquid crystal molecules 301L beside the first substrate 100 in the absence of the application of a voltage is placed at an angle of 1 degree or larger and 10 degrees or smaller in one of a clockwise direction and a counterclockwise direction (in FIG. 7, the clockwise direction) with respect to a direction perpendicular to the longitudinal direction 100E2A of the openings 100E2X, and the first polarizing axis 510A is placed at an angle larger than 0 degree and smaller than or equal to 2 degrees in the other of the clockwise direction and the counterclockwise direction (in FIG. 7, the counterclockwise direction) with respect to the alignment direction 301LA of the liquid crystal molecules 301L beside the first substrate 100 in the absence of the application of a voltage or with respect to a direction perpendicular to the alignment direction 301LA of the liquid crystal molecules 301L beside the first substrate 100 in the absence of the application of a voltage. The liquid crystal display device 1 of such an aspect can bring about further improvement in contrast.

In FIG. 7, in a plan view, the first polarizing axis 510A is placed at an angle larger than 0 degree and smaller than or equal to 2 degrees in the counterclockwise direction with respect to the alignment direction 301LA of the liquid crystal molecules 301L beside the first substrate 100 in the absence of the application of a voltage, and the second polarizing axis 520A is placed parallel to the longitudinal direction 100E2A of the openings 100E2X.

Alternatively, in a plan view, the first polarizing axis 510A may be placed at an angle larger than 0 degree and smaller than or equal to 2 degrees in the counterclockwise direction with respect to a direction perpendicular to the alignment direction 301LA of the liquid crystal molecules 301L beside the first substrate 100 in the absence of the application of a voltage, and in a plan view, the second polarizing axis 520A may be placed orthogonal to the longitudinal direction 100E2A of the openings 100E2X.

In a high-definition liquid crystal display device to which a configuration such as the present modification is applied, the actual alignment direction of the liquid crystal molecules 300L near the light-shielding film 100M deviates by a maximum of approximately 4 degrees due to the effect of a step of the light-shielding film 100M or other factors. Specifically, the actual alignment direction of the liquid crystal molecules 300L near the light-shielding film 100M deviates toward a direction perpendicular to the longitudinal direction 100E2A of the openings 100E2X. Therefore, in the present modification, the contrast of the liquid crystal display device 1 can be made higher than it is in Embodiment 2 by placing the first polarizing axis 510A closer to a direction perpendicular to the longitudinal direction 100E2A of the openings 100E2X than it is in Embodiment 2.

The following describes effects of the present disclosure with reference to examples; however, the present disclosure is not limited by these examples.

### Example 1 -1

A liquid crystal display device 1 of Example 1 -1 corresponding to the liquid crystal display device 1 of Embodiment 1 was fabricated. The liquid crystal display device of the present example was an active matric liquid crystal display device for use in an HMD of 1400 ppi. Each pixel (each pixel 1P) had a size of 18 μm per side, and each subpixel (picture element 10P) had a size of 6 μm×18 μm.

The liquid crystal display device 1 of the present example includes a first substrate 100 fabricated in the following manner. First, a gate wiring layer 120 including gate electrodes and gate lines 120L, a gate insulating layer (first insulating layer 130), TFTs (non-linear elements 100T) having IGZO (registered trademark) as semiconductor layers 100S, and a second insulating layer 160 were formed in sequence over a first support substrate 110. Next, through-holes 10CH1 for electrically connecting the semiconductor layers 100S and drain electrodes 150D were bored through the second insulating layer 160. Furthermore, a source wiring layer 150 including source electrodes, the drain electrodes 150D, and source lines 150L was formed on top of the second insulating layer 160. The gate lines 120L were extended parallel to a horizontal direction 11D of a screen 10, and the source lines 150L were extended parallel to a vertical direction 12D of the screen 10. The source lines 150L also function as a light-shielding film between the picture elements 10P. While IGZO (registered trademark) was used as the semiconductor layers 100S to drive the picture elements 10P, TFTs using p-Si as semiconductor layers were used in a peripheral circuit section of the liquid crystal display device 1.

Furthermore, on top of the source wiring layer 150, a color filter layer 170 composed of red color filters 170R, blue color filters 170B, and green color filters 170G was formed using colored organic resists. Next, a planarizing film 180 composed of an organic insulating film was formed on top of the color filter layer 170 to secure flatness. Next, through-holes 10CH2 for electrically connecting drain electrodes 150D of the TFTs and pixel electrodes (first electrodes 100E1) were bored through the color filter layer 170 and the planarizing film 180.

Next, for performing a display in an FFS mode, the first electrodes 100E1, which served as pixel electrodes, an insulating layer 100F, and a second electrode 100E2 serving as a common electrode were formed in this order over the planarizing film 180. The first electrodes 100E1 and the second electrode 100E2 were transparent electrodes. Next, an elongated light-shielding film 100M was formed from molybdenum on top of the second electrode 100E2, whereby the first substrate 100 was fabricated.

Furthermore, a first alignment film 410 and a spacer 600 for securing cell thickness were formed in this order over the light-shielding film 100M. Although, in the present example, the spacer 600 was formed on the first substrate 100, the spacer 600 may be formed on a second substrate 200 or may be formed on both the first substrate 100 and the second substrate 200.

The second electrode 100E2 had provided therein elongated openings 100E2X extending along a row direction or a column direction of the plurality of picture elements 10P, and in a plan view, a longitudinal direction 100E2A of the openings 100E2X was placed parallel (specifically, at an angle of 0 degree) to the vertical direction 12D of the screen 10. Further, in a plan view, a longitudinal direction of the light-shielding film 100M was also placed parallel (specifically, at an angle of 0 degree) to the vertical direction 12D of the screen 10.

The first alignment film 410 used was a photodegradable alignment film that, when irradiated with polarized ultraviolet rays, causes liquid crystal molecules to align themselves in a direction perpendicular to transmitted polarized light. A photo-alignment process was performed by irradiating the first alignment film 410 with polarized ultraviolet rays so that in a plan view, an alignment direction 301LA of liquid crystal molecules 301L beside the first substrate 100 in the absence of the application of a voltage formed an angle of 10 degrees in one of a clockwise direction and a counterclockwise direction (specifically, in the clockwise direction) with respect to the longitudinal direction 100E2A of the openings 100E2X.

Next, the second substrate 200 of the present example was fabricated by forming a second substrate side light-shielding film 20BM on a second support substrate 210. The second substrate side light-shielding film 20BM was placed on an outer frame of the screen 10 and was extended along the row direction (horizontal direction 11D) between two picture elements 10P that were adjacent to each other in the column direction (vertical direction 12D). The second substrate side light-shielding film 20BM was not placed between two picture elements 10P that were adjacent to each other in the row direction (i.e. was not placed along the column direction between two picture elements 10P that were adjacent to each other in the row direction).

Furthermore, a second alignment film 420 was formed on the second substrate side light-shielding film 20BM. An alignment process was performed on the second alignment film 420 so that in a plan view, an alignment direction 302LA of liquid crystal molecules 302L beside the second substrate 200 in the absence of the application of a voltage was placed parallel (specifically, at an angle of 0 degree) to the longitudinal direction 100E2A of the openings 100E2X.

A liquid crystal cell was fabricated by placing the first substrate 100 thus fabricated with the first alignment film 410 and the second substrate 200 thus fabricated with the second alignment film 420 so that the first alignment film 410 and the second alignment film 420 faced each other and bonding the two substrates together with the liquid crystal layer 300 sandwiched therebetween. Next, the first polarizing plate 510 having the first polarizing axis 510A was placed at a side of the first substrate 100 that faced away from the liquid crystal layer 300, and the second polarizing plate 520 having the second polarizing axis 520A was placed at a side of the second substrate 200 that faced away from the liquid crystal layer 300. To the liquid crystal cell, a driver and a driving circuit system were connected. Furthermore, a backlight system was placed at the back of the first polarizing plate 510. Thus, the liquid crystal display device 1 of the present example was fabricated.

Liquid crystal molecules 300L contained in the liquid crystal layer 300 were liquid crystal molecules having positive dielectric constant anisotropy and exhibiting a nematic phase within a given temperature range.

In a plan view, the first polarizing axis 510A was placed parallel (specifically, at an angle of 0 degree) to the alignment direction 301LA of the liquid crystal molecules 301L beside the first substrate 100 in the absence of the application of a voltage. Further, in a plan view, the second polarizing axis 520A was placed orthogonal (specifically, at an angle of 90 degrees) to the longitudinal direction 100E2A of the openings 100E2X and formed an angle of 80 degrees in the clockwise direction with respect to the first polarizing axis 510A.

The liquid crystal display device 1 of the present example had a contrast of 100 or higher. The contrast was measured using a “Luminance Colorimeter BM-5A” (manufactured by Topcon Technohouse Corp.).

Even a liquid crystal display device whose first polarizing axis 510A and second polarizing axis 520A are placed in directions differing by 90 degrees from those of the first polarizing axis 510A and the second polarizing axis 520A of Example 1-1, respectively, can bring about effects that are similar to those of Example 1-1.

### Example 1-2

A liquid crystal display device 1 of Example 1-2 corresponding to the liquid crystal display device 1 of Embodiment 1 was fabricated. The liquid crystal display device 1 of Example 1-2 had the same configuration as that of Example 1 -1 except that the alignment direction 301LA of the liquid crystal molecules 301L beside the first substrate 100 in the absence of the application of a voltage and the placement of the first polarizing axis 510A were different.

A photo-alignment process was performed by irradiating the first alignment film 410 with polarized ultraviolet rays so that in a plan view, an alignment direction 301LA of liquid crystal molecules 301L beside the first substrate 100 in the absence of the application of a voltage formed an angle of 5 degrees in one of a clockwise direction and a counterclockwise direction (specifically, in the clockwise direction) with respect to the longitudinal direction 100E2A of the openings 100E2X.

In a plan view, the first polarizing axis 510A was placed parallel (specifically, at an angle of 0 degree) to the alignment direction 301LA of the liquid crystal molecules 301L beside the first substrate 100 in the absence of the application of a voltage. Further, in a plan view, the second polarizing axis 520A was placed orthogonal (specifically, at an angle of 90 degrees) to the longitudinal direction 100E2A of the openings 100E2X and formed an angle of 85 degrees in the clockwise direction with respect to the first polarizing axis 510A.

The liquid crystal display device 1 of the present example had a contrast of 500 or higher. It was found from Examples 1-1 and 1-2 that the contrast of the liquid crystal display device 1 further improves as the angle formed by the alignment direction 301LA of the liquid crystal molecules 301L beside the first substrate 100 in the absence of the application of a voltage and the longitudinal direction 100E2A of the openings 100E2X becomes smaller in a plan view.

Even a liquid crystal display device whose first polarizing axis 510A and second polarizing axis 520A are placed in directions differing by 90 degrees from those of the first polarizing axis 510A and the second polarizing axis 520A of Example 1-2, respectively, can bring about effects that are similar to those of Example 1-2.

### Example 2

A liquid crystal display device 1 of Example 2 corresponding to the liquid crystal display device 1 of Embodiment 2 was fabricated. The liquid crystal display device 1 of Example 2 had the same configuration as that of Example 1-1 except that the liquid crystal molecules 300L had negative dielectric constant anisotropy, that the alignment process direction of the first alignment film 410 and the second alignment film 420 was different by 90 degrees from that of Example 1-1, and that the placement of the first polarizing axis 510A and second polarizing axis 520A was different by 90 degrees from that of Example 1-1.

A photo-alignment process was performed by irradiating the first alignment film 410 with polarized ultraviolet rays so that in a plan view, an alignment direction 301LA of liquid crystal molecules 301L beside the first substrate 100 in the absence of the application of a voltage formed an angle of 10 degrees in one of a clockwise direction and a counterclockwise direction (specifically, in the clockwise direction) with respect to a direction perpendicular to the longitudinal direction 100E2A of the openings 100E2X. That is, in a plan view, the alignment direction 301LA of the liquid crystal molecules 301L beside the first substrate 100 in the absence of the application of a voltage formed an angle of 100 degrees with respect to the longitudinal direction 100E2A of the openings 100E2X.

In the present example, an alignment process was performed on the second alignment film 420 so that in a plan view, an alignment direction 302LA of liquid crystal molecules 302L beside the second substrate 200 in the absence of the application of a voltage was placed orthogonal (specifically, at an angle of 90 degrees) to the longitudinal direction 100E2A of the openings 100E2X.

In the present example, in a plan view, the first polarizing axis 510A was placed parallel (specifically, at an angle of 0 degree) to the alignment direction 301LA of the liquid crystal molecules 301L beside the first substrate 100 in the absence of the application of a voltage. That is, in a plan view, the first polarizing axis 510A formed an angle of 100 degrees with respect to the longitudinal direction 100E2A of the openings 100E2X.

In the present example, in a plan view, the second polarizing axis 520A was placed parallel (specifically, at an angle of 0 degree) to the longitudinal direction 100E2A of the openings 100E2X and formed an angle of 80 degrees in the clockwise direction with respect to the first polarizing axis 510A.

The contrast of the liquid crystal display device 1 of Example 2 was about equal to that of Example 1-1. While the transmittance of the liquid crystal display device 1 was higher in Example 2 than in Example 1-1, the response speed was higher in Example 1-1 than in Example 2. The transmittance and the response speed were both measured by an “LCD-5200” (manufactured Otsuka Electronics Co., Ltd.).

Even a liquid crystal display device whose first polarizing axis 510A and second polarizing axis 520A are placed in directions differing by 90 degrees from those of the first polarizing axis 510A and the second polarizing axis 520A of Example 2, respectively, can bring about effects that are similar to those of Example 2.

### Example 3

A liquid crystal display device 1 of Example 3 corresponding to the modification of Embodiment 1 was fabricated. The liquid crystal display device 1 of Example 3 had the same configuration as that of Example 1-1 except that the placement of the first polarizing axis 510A was different.

In the present example, in a plan view, the first polarizing axis 510A was placed at an angle of 8 degrees in the clockwise direction with respect to the longitudinal direction 100E2A of the openings 100E2X. Specifically, in a plan view, the first polarizing axis 510A was placed at an angle of 2 degrees in the other of the clockwise direction and the counterclockwise direction (specifically, in the counterclockwise direction) with respect to the alignment direction 301LA of the liquid crystal molecules 301L beside the first substrate 100 in the absence of the application of a voltage. That is, the second polarizing axis 520A was placed at an angle of 82 degrees in the clockwise direction with respect to the first polarizing axis 510A. The contrast of the liquid crystal display device 1 of the present example improved by 4% as compared with Example 1-1.

Even a liquid crystal display device whose first polarizing axis 510A and second polarizing axis 520A are placed in directions differing by 90 degrees from those of the first polarizing axis 510A and the second polarizing axis 520A of Example 3, respectively, can bring about effects that are similar to those of Example 3.

### Example 4

A liquid crystal display device 1 of Example 4 corresponding to the modification of Embodiment 2 was fabricated. The liquid crystal display device 1 of Example 4 had the same configuration as that of Example 2 except that the placement of the first polarizing axis 510A was different.

In the present example, in a plan view, the first polarizing axis 510A was placed at an angle of 98 degrees in the clockwise direction with respect to the longitudinal direction 100E2A of the openings 100E2X. Specifically, in a plan view, the first polarizing axis 510A was placed at an angle of 2 degrees in the other of the clockwise direction and the counterclockwise direction (specifically, in the counterclockwise direction) with respect to the alignment direction 301LA of the liquid crystal molecules 301L beside the first substrate 100 in the absence of the application of a voltage. That is, the second polarizing axis 520A was placed at an angle of 82 degrees in the clockwise direction with respect to the first polarizing axis 510A. The contrast of the liquid crystal display device 1 of the present example improved by 4% as compared with Example 2.

Even a liquid crystal display device whose first polarizing axis 510A and second polarizing axis 520A are placed in directions differing by 90 degrees from those of the first polarizing axis 510A and the second polarizing axis 520A of Example 4, respectively, can bring about effects that are similar to those of Example 4.

### Example 5

A liquid crystal display device 1 of Example 5 was fabricated in the same manner as that of Example 1-1 except that S-811 (manufactured by Merck Electronics, Inc.) was added as a chiral dopant to the liquid crystal layer 300. The chiral dopant was added into the liquid crystal layer 300 so that the alignment direction 301LA of the liquid crystal molecules 301L beside the first substrate 100 becomes twisted from the first substrate 100 toward the second substrate 200 in a direction having an inclination with respect to the longitudinal direction 100E2A of the openings 100E2X of the second electrode 100E2. In Example 5, a value (thickness of liquid crystal layer/twist pitch) obtained by dividing the thickness of the liquid crystal layer 300 by the twist pitch was 0.07. The response speed (Ton) of the liquid crystal display device 1 of Example 5 in the presence of the application of a voltage was higher by approximately 7% than the response speed (Ton) of the liquid crystal display device 1 of Example 1-1 in the presence of the application of a voltage. The response speed (Toff) of the liquid crystal display device 1 of Example 5 during a return was about equal to the response speed (Toff) of the liquid crystal display device 1 of Example 1-1 during a return.

Even a liquid crystal display device whose first polarizing axis 510A and second polarizing axis 520A are placed in directions differing by 90 degrees from those of the first polarizing axis 510A and the second polarizing axis 520A of Example 5, respectively, can bring about effects that are similar to those of Example 5.

### Example 6

A liquid crystal display device 1 of Example 6 was fabricated in the same manner as that of Example 2 except that S-811 (manufactured by Merck Electronics, Inc.) was added as a chiral dopant to the liquid crystal layer 300. The chiral dopant was added into the liquid crystal layer 300 so that the alignment direction 301LA of the liquid crystal molecules 301L beside the first substrate 100 becomes twisted from the first substrate 100 toward the second substrate 200 in a direction having an inclination with respect to a direction perpendicular to the longitudinal direction 100E2A of the openings 100E2X of the second electrode 100E2. In Example 6, a value (thickness of liquid crystal layer/twist pitch) obtained by dividing the thickness of the liquid crystal layer 300 by the twist pitch was 0.07. The response speed (Ton) of the liquid crystal display device 1 of Example 6 in the presence of the application of a voltage was higher by approximately 7% than the response speed (Ton) of the liquid crystal display device 1 of Example 2 in the presence of the application of a voltage. The response speed (Toff) of the liquid crystal display device 1 of Example 6 during a return was about equal to the response speed (Toff) of the liquid crystal display device 1 of Example 2 during a return.

Even a liquid crystal display device whose first polarizing axis 510A and second polarizing axis 520A are placed in directions differing by 90 degrees from those of the first polarizing axis 510A and the second polarizing axis 520A of Example 6, respectively, can bring about effects that are similar to those of Example 6.

The foregoing has described embodiments of the present disclosure and modifications thereof; however, the present disclosure is not limited to the embodiments and the modifications thereof but can be carried out in various aspects and modifications thereof without departing from the scope of the present disclosure. Further, a plurality of constituent elements disclosed in the embodiments and the modifications thereof can be altered as appropriate. For example, one of all constituent elements shown in an embodiment or modification may be added as a constituent element of another embodiment or modification, or some of all constituent elements shown in an embodiment or modification may be deleted from the embodiment or modification.

Further, the drawings mostly schematically show each constituent element to facilitate understanding of the disclosure, and the thickness, length, number, spacing, or other attributes of each constituent element may be different from actual ones for the convenience of preparation of the drawings. Further, a configuration of each constituent element shown in the foregoing embodiments is merely an example and is not limited in particular, and various changes can be made without substantially departing from the effects of the present disclosure.

Embodiments of the present disclosure provide solutions described in the following items.

### Item 1

A liquid crystal display device having a plurality of picture elements arranged in a matrix including a plurality of rows and a plurality of columns, the liquid crystal display device comprising:
a first polarizing plate having a first polarizing axis;
a first substrate having a plurality of non-linear elements placed separately in correspondence with each of the picture elements;
a liquid crystal layer containing liquid crystal molecules;
a second substrate; and
a second polarizing plate having a second polarizing axis,
wherein
the first polarizing plate, the first substrate, the liquid crystal layer, the second substrate, and the second polarizing plate are arranged in this order from a back side toward a viewing screen side,
the first substrate further includes a first electrode, an insulating layer, and a second electrode in which elongated openings extending along a row direction or a column direction of the plurality of picture elements are provided separately for each of the picture elements,
the first electrode, the insulating layer, and the second electrode are arranged in this order toward the liquid crystal layer, and
in a plan view, the second polarizing axis is placed parallel or orthogonal to a longitudinal direction of the openings and is placed at an angle of 80 degrees or larger and 89 degrees or smaller with respect to the first polarizing axis.

### Item 2

The liquid crystal display device according to Item 1, wherein
the liquid crystal molecules have positive dielectric constant anisotropy,
in a plan view, an alignment direction of liquid crystal molecules beside the first substrate in absence of application of a voltage is placed at an angle of 1 degree or larger and 10 degrees or smaller in one of a clockwise direction and a counterclockwise direction with respect to the longitudinal direction of the openings, and
in a plan view, an alignment direction of liquid crystal molecules beside the second substrate in the absence of the application of a voltage is placed parallel to the longitudinal direction of the openings.

### Item 3

The liquid crystal display device according to Item 2, wherein in a plan view, the first polarizing axis is placed parallel or orthogonal to the alignment direction of the liquid crystal molecules beside the first substrate in the absence of the application of a voltage.

### Item 4

The liquid crystal display device according to Item 2, wherein in a plan view, the first polarizing axis is placed at an angle larger than 0 degree and smaller than or equal to 2 degrees in the other of the clockwise direction and the counterclockwise direction with respect to the alignment direction of the liquid crystal molecules beside the first substrate in the absence of the application of a voltage or with respect to a direction perpendicular to the alignment direction of the liquid crystal molecules beside the first substrate in the absence of the application of a voltage.

### Item 5

The liquid crystal display device according to Item 1, wherein
the liquid crystal molecules have negative dielectric constant anisotropy,
in a plan view, an alignment direction of liquid crystal molecules beside the first substrate in absence of application of a voltage is placed at an angle of 1 degree or larger and 10 degrees or smaller in one of a clockwise direction and a counterclockwise direction with respect to a direction perpendicular to the longitudinal direction of the openings, and
in a plan view, an alignment direction of liquid crystal molecules beside the second substrate in the absence of the application of a voltage is placed orthogonal to the longitudinal direction of the openings.

### Item 6

The liquid crystal display device according to Item 5, wherein in a plan view, the first polarizing axis is placed parallel or orthogonal to the alignment direction of the liquid crystal molecules beside the first substrate in the absence of the application of a voltage.

### Item 7

The liquid crystal display device according to Item 5, wherein in a plan view, the first polarizing axis is placed at an angle larger than 0 degree and smaller than or equal to 2 degrees in the other of the clockwise direction and the counterclockwise direction with respect to the alignment direction of the liquid crystal molecules beside the first substrate in the absence of the application of a voltage or with respect to a direction perpendicular to the alignment direction of the liquid crystal molecules beside the first substrate in the absence of the application of a voltage.

### Item 8

The liquid crystal display device according to any one of Items 1 to 7, wherein
the first substrate further includes a gate line, and
in a plan view, the gate line is placed orthogonal to the longitudinal direction of the openings.

### Item 9

The liquid crystal display device according to any one of Items 1 to 8, wherein
the liquid crystal layer further contains a chiral dopant,
the liquid crystal molecules are in twist alignment, and
a value obtained by dividing a thickness of the liquid crystal layer by a twist pitch between the liquid crystal molecules is less than or equal to 0.125.

### Item 10

The liquid crystal display device according to any one of Items 1 to 9, wherein the first substrate further includes a color filter layer and a planarizing film placed at a side of the color filter layer that faces the liquid crystal layer.

### Item 11

The liquid crystal display device according to any one of Items 1 to 10, wherein
the first substrate further includes an elongated light-shielding film placed between the plurality of picture elements, and
in a plan view, a longitudinal direction of the light-shielding film is placed parallel to the longitudinal direction of the openings.

The present disclosure contains subject matter related to that disclosed in Japanese Priority Patent Application JP 2024-226516 filed in the Japan Patent Office on Dec. 23, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid crystal display device having a plurality of picture elements arranged in a matrix including a plurality of rows and a plurality of columns, the liquid crystal display device comprising:
a first polarizing plate having a first polarizing axis;
a first substrate having a plurality of non-linear elements placed separately in correspondence with each of the picture elements;
a liquid crystal layer containing liquid crystal molecules;
a second substrate; and
a second polarizing plate having a second polarizing axis,
wherein
the first polarizing plate, the first substrate, the liquid crystal layer, the second substrate, and the second polarizing plate are arranged in this order from a back side toward a viewing screen side,
the first substrate further includes a first electrode, an insulating layer, and a second electrode in which elongated openings extending along a row direction or a column direction of the plurality of picture elements are provided separately for each of the picture elements,
the first electrode, the insulating layer, and the second electrode are arranged in this order toward the liquid crystal layer, and
in a plan view, the second polarizing axis is placed parallel or orthogonal to a longitudinal direction of the openings and is placed at an angle of 80 degrees or larger and 89 degrees or smaller with respect to the first polarizing axis.

2. The liquid crystal display device according to Claim 1, wherein
the liquid crystal molecules have positive dielectric constant anisotropy,
in a plan view, an alignment direction of liquid crystal molecules beside the first substrate in absence of application of a voltage is placed at an angle of 1 degree or larger and 10 degrees or smaller in one of a clockwise direction and a counterclockwise direction with respect to the longitudinal direction of the openings, and
in a plan view, an alignment direction of liquid crystal molecules beside the second substrate in the absence of the application of a voltage is placed parallel to the longitudinal direction of the openings.

3. The liquid crystal display device according to Claim 2, wherein in a plan view, the first polarizing axis is placed parallel or orthogonal to the alignment direction of the liquid crystal molecules beside the first substrate in the absence of the application of a voltage.

4. The liquid crystal display device according to Claim 2, wherein in a plan view, the first polarizing axis is placed at an angle larger than 0 degree and smaller than or equal to 2 degrees in the other of the clockwise direction and the counterclockwise direction with respect to the alignment direction of the liquid crystal molecules beside the first substrate in the absence of the application of a voltage or with respect to a direction perpendicular to the alignment direction of the liquid crystal molecules beside the first substrate in the absence of the application of a voltage.

5. The liquid crystal display device according to Claim 1, wherein
the liquid crystal molecules have negative dielectric constant anisotropy,
in a plan view, an alignment direction of liquid crystal molecules beside the first substrate in absence of application of a voltage is placed at an angle of 1 degree or larger and 10 degrees or smaller in one of a clockwise direction and a counterclockwise direction with respect to a direction perpendicular to the longitudinal direction of the openings, and
in a plan view, an alignment direction of liquid crystal molecules beside the second substrate in the absence of the application of a voltage is placed orthogonal to the longitudinal direction of the openings.

6. The liquid crystal display device according to Claim 5, wherein in a plan view, the first polarizing axis is placed parallel or orthogonal to the alignment direction of the liquid crystal molecules beside the first substrate in the absence of the application of a voltage.

7. The liquid crystal display device according to Claim 5, wherein in a plan view, the first polarizing axis is placed at an angle larger than 0 degree and smaller than or equal to 2 degrees in the other of the clockwise direction and the counterclockwise direction with respect to the alignment direction of the liquid crystal molecules beside the first substrate in the absence of the application of a voltage or with respect to a direction perpendicular to the alignment direction of the liquid crystal molecules beside the first substrate in the absence of the application of a voltage.

8. The liquid crystal display device according to Claim 1, wherein
the first substrate further includes a gate line, and
in a plan view, the gate line is placed orthogonal to the longitudinal direction of the openings.

9. The liquid crystal display device according to Claim 1, wherein
the liquid crystal layer further contains a chiral dopant,
the liquid crystal molecules are in twist alignment, and
a value obtained by dividing a thickness of the liquid crystal layer by a twist pitch between the liquid crystal molecules is less than or equal to 0.125.

10. The liquid crystal display device according to Claim 1, wherein the first substrate further includes a color filter layer and a planarizing film placed at a side of the color filter layer that faces the liquid crystal layer.

11. The liquid crystal display device according to Claim 1, wherein
the first substrate further includes an elongated light-shielding film placed between the plurality of picture elements, and
in a plan view, a longitudinal direction of the light-shielding film is placed parallel to the longitudinal direction of the openings.
